(19) United States
(12) Patent Application Publication
(10) Pub. No.: US 2024/0162584 A1
(43) Pub. Date: May 16, 2024

(54) SEALED BATTERY, AND BATTERY PACK USING SAME

(71) Applicant: Panasonic Energy Co., Ltd., Moriguchi-shi, Osaka (JP)

(72) Inventor: Kenichi Honoki, Tokushima (JP)

(73) Assignee: Panasonic Energy Co., Ltd., Moriguchi-shi, Osaka (JP)

(21) Appl. No.: 18/281,368

(22) PCT Filed: Mar. 8, 2022
(86) PCT No.: PCT/JP2022/010062

§ 371 Date: Sep. 11, 2023

(30) Foreign Application Priority Data
Mar. 19, 2021 (JP) 2021-045837

(51) Int. Cl. H01M 50/578; H01M 50/107; H01M 50/342

(52) U.S. Cl. CPC H01M 50/578; H01M 50/107; H01M 50/3425; H01M 2200/20

(57) ABSTRACT

A sealed battery comprises: a bottomed tubular outer can accommodating an electrode body; and a sealing body for sealing an opening of the outer can. The present invention is characterized in that: the sealing body includes a current blocking mechanism that seals the electrode body together with the outer can and is activated in response to gas pressure inside the battery, and a cap that forms a sealed space above the current blocking mechanism; and the cap includes an explosion-proof valve that opens in response to the gas pressure inside the battery.

### TECHNICAL FIELD

The present invention relates to a sealed battery, and a battery pack using the same.

### BACKGROUND ART

A sealed battery such as a non-aqueous electrolyte secondary battery is required to have a high capacity and a high energy density to improve the performance of the sealed battery. As the technology that supports the high capacity of a battery, it has become necessary to mount a current interruption mechanism and an explosion-proof mechanism that operate when an abnormality occurs in the battery.

As a technology in which a battery pack is designed to have the high energy density, there is a technology in which positive electrode current collector plates and negative electrode current collector plates for connecting a plurality of cylindrical batteries in series or parallel are arranged in the same plane to reduce the occupying volume of the current collector plates, thereby providing the high energy density.

PATENT LITERATURE 1 discloses a sealed battery in which a current interruption mechanism and an explosion-proof mechanism are formed by vent members in a sealing assembly.

### CITATION LIST

### Patent Literature

PATENT LITERATURE 1: Japanese Unexamined Patent Application Publication No. 2020-135929

### SUMMARY

### Technical Problem

In the battery of PATENT LITERATURE 1, a gas discharge hole is provided in a cap on a top surface side of the sealing assembly, the cap serving as a positive electrode terminal of the battery. In a case of a battery pack in which a plurality of batteries are connected by arranging the positive electrode terminals in the same direction, gas discharged at the time of a thermal runaway flows from the gas discharge hole of the adjacent battery, which thermally affects the current interruption mechanism and the explosion-proof mechanism. Alternatively, when the pressure in the battery pack becomes high due to the discharged gas of the thermal runaway battery, this affects the pressures at which the current interruption mechanism and the explosion-proof mechanism of the adjacent battery are actuated through the gas discharge hole.

It is an advantage of the present disclosure to provide a sealed battery in which, in the case of being used for a battery pack that houses a plurality of sealed batteries, a current interruption mechanism and an explosion-proof mechanism are less affected even when an adjacent battery discharges gas due to a thermal runaway, and a battery pack using the sealed battery.

### Solution to Problem

A sealed battery according to the present disclosure comprises a bottomed cylindrical outer housing can that houses an electrode assembly and a sealing assembly that closes an opening of the outer housing can. The sealing assembly seals the electrode assembly in cooperation with the outer housing can, and has a current interruption mechanism which is activated sensitive to a gas pressure in the battery and a cap that forms a sealed space above the current interruption mechanism, and the cap has an explosion-proof vent that opens sensitive to a gas pressure in the sealed space.

### Advantageous Effects of Invention

In the sealed battery according to the present disclosure, an explosion-proof vent is provided in a cap of a sealing assembly to form a sealed space between a current interruption mechanism and the cap, and in the case of being used for a battery pack that houses a plurality of sealed batteries, a current interruption mechanism and an explosion-proof mechanism are less affected by other batteries even when an adjacent battery discharges gas due to a thermal runaway.

### BRIEF DESCRIPTION OF DRAWING

FIG. 1 is a sectional view of a sealed battery of an embodiment.

FIG. 2 is a diagram illustrating appearance of a battery pack of an embodiment.

FIG. 3 is a diagram illustrating an internal structure of the battery pack of an embodiment.

FIG. 4 is a diagram illustrating arrangement of current collector plates of the battery pack of an embodiment.

FIG. 5A is a diagram illustrating an outer housing can used for an example and a comparative example, and a diagram illustrating a case where an explosion-proof vent is not provided in the outer housing can.

FIG. 5B is a diagram illustrating an outer housing can used for an example and a comparative example, and a diagram illustrating a case where an explosion-proof vent is provided in a bottom of the outer housing can.

FIG. 6A is a diagram illustrating a form of a sealing assembly of a battery used for an example and a comparative example, and a diagram illustrating a case where a top surface of the sealing assembly has an explosion-proof vent.

FIG. 6B is a diagram illustrating a form of a sealing assembly of a battery used for an example and a comparative example, and a diagram illustrating a case where a side wall of the sealing assembly has a gas discharge hole.

FIG. 6C is a diagram illustrating a form of a sealing assembly of a battery used for an example and a comparative example, and a diagram illustrating a case where the sealing assembly has neither explosion-proof vent nor gas discharge hole.

FIG. 7A is a diagram illustrating a section of a battery holder used for an example and a comparative example, and a diagram illustrating the battery holder for discharging gas from an upper surface.

FIG. 7B is a diagram illustrating a section of a battery holder used for an example and a comparative example, and a diagram illustrating the battery holder for discharging gas from a bottom.

### DESCRIPTION OF EMBODIMENTS

Hereinafter, an embodiment of the present disclosure will be described in detail with reference to the drawings. In the following description, specific shapes, materials, directions, values, and the like, which are examples for facilitating understanding of the present disclosure, may be appropriately modified with the usage, purpose, specifications, and so on. The selective combination of components of embodiments and modified examples, which are described below, are anticipated in advance.

Hereinafter, as an example of a sealed battery, there is illustrated a non-aqueous electrolyte secondary battery in which an electrode assembly 14 is housed in a bottomed cylindrical outer housing can 16 and an opening of the outer housing can 16 is capped with a sealing assembly 17, but the sealed battery may be applied to various types of sealed batteries such as a nickel hydrogen secondary battery in addition to the non-aqueous electrolyte secondary battery.

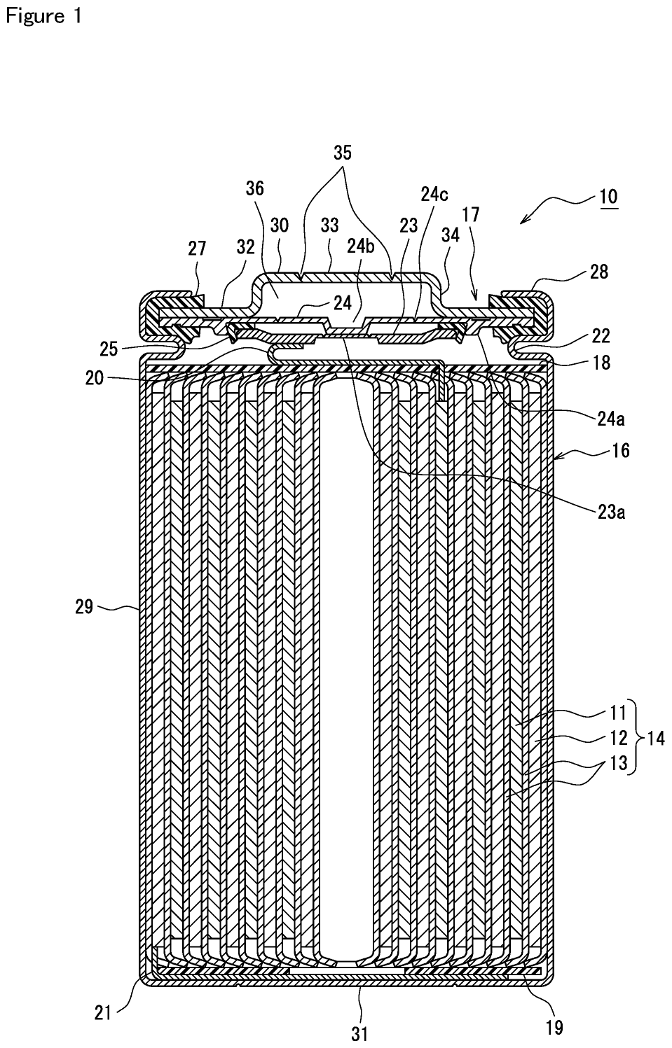

FIG. 1 is a sectional view of a sealed battery 10 of an embodiment of the present disclosure. As illustrated in FIG. 1, the sealed battery 10 comprises the bottomed cylindrical outer housing can 16, the sealing assembly 17 that caps an opening of the outer housing can 16, and a gasket 27 interposed between the outer housing can 16 and the sealing assembly 17. The sealed battery 10 comprises the electrode assembly 14 and an electrolyte that are housed in the outer housing can 16. The electrode assembly 14 includes a positive electrode 11, a negative electrode 12, and a separator 13, and has a wound structure in which the positive electrode 11 and the negative electrode 12 are spirally wound with the separator 13 interposed therebetween.

The non-aqueous electrolyte includes a non-aqueous solvent, and an electrolyte salt dissolved in the non-aqueous solvent. Examples of the non-aqueous solvent may include esters, ethers, nitriles, amides, and mixed solvents containing two or more selected from the foregoing. The non-aqueous solvent may contain a halogen-substituted product obtained by substituting at least some of hydrogen atoms in these solvents with a halogen atom such as fluorine. Note that the non-aqueous electrolyte is not limited to a liquid electrolyte and may be a solid electrolyte that uses a gel polymer or the like. As the electrolyte salt, a lithium salt such as LiPF6 is used.

The electrode assembly 14 includes the long positive electrode 11, the long negative electrode 12, and the two long separators 13. The electrode assembly 14 also includes a positive electrode lead 20 joined to the positive electrode 11 and a negative electrode lead 21 joined to the negative electrode 12. The negative electrode 12 is formed into a larger size than size of the positive electrode 11 in order to suppress precipitation of lithium, and therefore is formed to be longer in the longitudinal direction and the width direction (short direction) than the positive electrode 11. The two separators 13 are each formed to be at least one size larger than the positive electrode 11, and are disposed so as to vertically interpose, for example, the positive electrode 11 therebetween.

The positive electrode 11 includes a positive electrode current collector and a positive electrode mixture layer formed on each surface of the positive electrode current collector. Examples of the positive electrode current collector may include a foil of a metal such as aluminum or an aluminum alloy, which is stable within a potential range of the positive electrode 11, and a film in which such a metal is disposed on a surface layer thereof. The positive electrode mixture layer includes a positive electrode active material, a conductive agent, and a binder. The positive electrode 11 can be produced by, for example, applying a positive electrode mixture slurry including a positive electrode active material, a conductive agent, a binder, and the like on a positive electrode current collector, drying the resulting coating film, and then compressing the coating film to form a positive electrode mixture layer on each surface of the current collector.

The positive electrode active material is mainly composed of a lithium-containing metal composite oxide. Examples of metal elements contained in the lithium-containing metal composite oxide include Ni, Co, Mn, Al, B, Mg, Ti, V, Cr, Fe, Cu, Zn, Ga, Sr, Zr, Nb, In, Sn, Ta, and W. An example of the lithium-containing metal composite oxide is preferably a composite oxide containing at least one of Ni, Co, Mn and Al.

Examples of the conductive agent included in the positive electrode mixture layer may include carbon materials such as carbon black, acetylene black, Ketjen black, and graphite. Examples of the binder included in the positive electrode mixture layer may include fluorocarbon resins such as polytetrafluoroethylene (PTFE) and polyvinylidene fluoride (PVdF), polyacrylonitrile (PAN), polyimide, acrylic resins, and polyolefin. These resins may be used in combination with cellulose derivatives such as carboxymethyl cellulose (CMC) or a salt thereof, a polyethylene oxide (PEO), or the like.

The negative electrode 12 includes a negative electrode current collector and a negative electrode mixture layer formed on each surface of the negative electrode current collector. Examples of the negative electrode current collector may include a foil of a metal such as copper or a copper alloy, which is stable within a potential range of the negative electrode 12, and a film in which such a metal is disposed on a surface layer thereof. The negative electrode mixture layer includes a negative electrode active material, and a binder. The negative electrode 12 can be produced by, for example, applying a negative electrode mixture slurry including a negative electrode active material, a binder, and the like on a negative electrode current collector, drying the resulting coating film, and then compressing the coating film to form a negative electrode mixture layer on each surface of the current collector.

As the negative electrode active material, a carbon material that reversibly occludes and releases lithium ions is generally used. A preferable carbon material is graphite including natural graphite such as flaky graphite, massive graphite, and earthy graphite, and artificial graphite such as massive artificial graphite and graphitized mesophase carbon microbeads. As the negative electrode active material, an Si-containing compound may be included in the negative electrode mixture layer. As the negative electrode active material, a metal alloyed with lithium other than Si, an alloy containing such a metal, a compound containing such a metal, and the like may be used.

As the binder included in the negative electrode mixture layer, fluorocarbon resins, PAN, polyimide resins, acrylic resins, polyolefin resins, and the like may be used as in the case of the positive electrode 11, and a styrene-butadiene rubber (SBR) or a modification thereof is preferably used. As the negative electrode mixture layer, for example, in addition to SBR and the like, CMC or a salt thereof, polyacrylic acid (PAA) or a salt thereof, polyvinyl alcohol, or the like may be included.

A porous sheet having ion permeability and an insulation property is used as the separator 13. Specific examples of the porous sheet include a microporous thin film, a woven fabric, and a nonwoven fabric. The material of the separator 13 is preferably a polyolefin resin such as polyethylene or polypropylene, or a cellulose. The separator 13 may have either a single layer structure or a laminated structure. A heat-resistant layer or the like may be formed on a surface of the separator 13. Note that the negative electrode 12 may include a winding start end of the electrode assembly 14, but the separator 13 generally extends beyond a winding start side end of the negative electrode 12, and a winding start side end of the separator 13 serves as the winding start end of the electrode assembly 14.

In the example illustrated in FIG. 1, the positive electrode lead 20 is electrically connected to an intermediate portion in the winding direction of a positive electrode core, and the negative electrode lead 21 is electrically connected to a winding finish end in the winding direction of a negative electrode core. However, the negative electrode lead may be electrically connected to a winding start end in the winding direction of the negative electrode core. Alternatively, the electrode assembly may have two negative electrode leads in which one of the negative electrode leads is electrically connected to the winding start end in the winding direction of the negative electrode core, and the other negative electrode lead is electrically connected to the winding finish end in the winding direction of the negative electrode core. Alternatively, a winding finish side end in the winding direction of the negative electrode core may be brought into contact with an inner surface of the outer housing can so that the negative electrode and the outer housing can is electrically connected.

As illustrated in FIG. 1, the sealed battery 10 further includes an insulating plate 18 disposed on the upper side of the electrode assembly 14, and an insulating plate 19 disposed on the lower side of the electrode assembly 14. In the example illustrated in FIG. 1, the positive electrode lead 20 attached to the positive electrode 11 extends toward the sealing assembly 17 through a through hole of the insulating plate 18, and the negative electrode lead 21 attached to the negative electrode 12 extends toward a bottom 31 of the outer housing can 16 along the outside of the insulating plate 19. The positive electrode lead 20 is connected to a lower face of an internal terminal plate 23, which is a bottom plate of the sealing assembly 17, by welding or the like, and a cap 30, which is a top plate of the sealing assembly 17 electrically connected to the internal terminal plate 23, becomes a positive electrode external terminal. The negative electrode lead 21 is connected to an inner surface of the bottom 31 of the outer housing can 16 by welding or the like, and the outer housing can 16 becomes a negative electrode external terminal. The structure of the sealing assembly 17 will be described later in detail.

The outer housing can 16 is a metal container having a bottomed cylindrical shape. A portion between the outer housing can 16 and the sealing assembly 17 is enclosed by the annular gasket 27, and an internal space of the battery is sealed by the enclosure. The gasket 27 is held between the outer housing can 16 and the sealing assembly 17, and insulates the sealing assembly 17 from the outer housing can 16. The gasket 27 has a role of a sealing material for maintaining the airtightness of the inside of the battery, so as to prevent leakage of an electrolytic solution. In addition, the gasket 27 also has a role as an insulating material to prevent a short circuit between the outer housing can 16 and the sealing assembly 17.

An upper portion of the outer housing can 16 is provided with a grooved portion 22 recessed inward in the radial direction by spinning a part of a cylindrical outer circumferential surface, and an opening end of the outer housing can 16 is provided with an annular caulking portion 28. A bottomed cylindrical portion 29 houses the electrode assembly 14 and the non-aqueous electrolyte, and the caulking portion 28 is bent inward in the radial direction from an end on the opening side of the bottomed cylindrical portion 29 to extend inward in the radial direction. The sealing assembly 17 is fixed, together with the gasket 27, to the outer housing can 16 in a state being held between the caulking portion 28 and an upper side of the grooved portion 22.

Next, the structure of the sealing assembly 17 will be described. The sealing assembly 17 has a structure in which the internal terminal plate 23, an insulating member 25, a rupture disc 24, and the cap 30 are arranged in parallel. Each member constituting the sealing assembly 17 has, for example, a disc shape or a ring shape, and members except for the insulating member 25 are electrically connected to each other.

The internal terminal plate 23 is a metallic plate having a disc shape, and a diameter of the internal terminal plate 23 is formed to be smaller than the diameter of the rupture disc 24. A center portion of the internal terminal plate 23 forms a thin wall portion 23a with the wall thickness relatively small. A notched portion 23b is formed around the thin wall portion 23a. The insulating member 25 is attached to a peripheral edge of the internal terminal plate 23.

The rupture disc 24 is a metallic plate having a disc shape, and has a projection 24a on a lower surface thereof, and the internal terminal plate 23 with the insulating member attached thereto is inserted into the projection 24a to caulk the projection 24a inward in the radial direction, whereby the internal terminal plate 23 is fixed to the rupture disc 24 via the insulating member 25.

A center portion of the rupture disc 24 is provided with a recess 24b and contacts the internal terminal plate 23, and the recess 24b and the internal terminal plate 23 are electrically connected by welding.

The rupture disc 24 has a circumferential groove 24c. The rupture disc 24 and the internal terminal plate 23 form a current interruption mechanism. As described later, when the notched portion 23b of the internal terminal plate 23 ruptures, the thin wall portion 23a is separated from the internal terminal plate 23, and a portion of the internal terminal plate 23 to which the positive electrode lead 20 is connected is disconnected from the rupture disc 24, whereby a current pathway is cut off.

The cap 30 includes a circular top surface 33 which is raised at a center portion in the radial direction and a flange 32 which is provided around the top surface 33 to extend toward the peripheral edge. The cap 30 is electrically connected, at the peripheral edge, to the rupture disc 24, and the cap 30 serves as the positive electrode of the battery. An explosion-proof vent 35 is formed in the top surface 33 of the cap 30. The explosion-proof vent 35 is formed by a groove or the like formed by engraving or the like in the top surface 33 of the cap 30. The explosion-proof vent 35 may have any shape such as a C-shape and a round shape. Note that the explosion-proof vent 35 may not be necessarily provided in the top surface 33 of the cap 30. It is only required that the explosion-proof vent 35 is provided in any position of a corner in the radial direction of the top surface 33 of the cap 30 and a side wall 34 extending from the top surface 33 to the flange 32.

Unlike the conventional sealed battery, the sealed battery 10 of the present embodiment has no gas discharge hole in the cap 30. Therefore, the sealing assembly 17 of the sealed battery 10 of the present embodiment has a sealed space 36 formed between the rupture disc 24 and the cap 30. The sealed battery 10 is sealed from the outside of the battery, thereby providing a configuration which makes it difficult to transmit a flow and temperature of air outside the battery to the interior of the battery. As described later, the sealed space 36 enables the rupture disc 24 to be sealed from the outside of the battery, thereby providing a configuration in which the battery is less affected even when the adjacent battery discharges gas in the battery pack in which batteries are arranged adjacently.

Next, a current interruption mechanism and an explosion-proof mechanism of the sealed battery 10 of the present embodiment will be described.

When a gas pressure in the battery becomes high due to an internal short circuit or the like, a pressure is generated by which the thin wall portion 23a of the internal terminal plate 23 pushes up the rupture disc 24 toward the cap 30. When the gas pressure in the battery is greater than or equal to a predetermined pressure relative to the pressure in the sealed space 36, the thin wall portion 23a of the internal terminal plate 23 breaks at the notched portion 23b, whereby the thin wall portion 23a and the rupture disc 24 are separated from the internal terminal plate 23. This cuts off the current path between the rupture disc 24 and the internal terminal plate 23. When the internal pressure further rises, the groove 24c of the rupture disc 24 ruptures, and the sealing of the sealed space 36 breaks, whereby the pressure in the sealed space 36 rises due to a gas pressure generated in the battery. When the pressure in the battery further rises due to the thermal runaway in the battery or the like, the explosion-proof vent 35 provided in the cap 30 breaks, whereby the gas is discharged to the outside of the battery. This can prevent the battery from rupturing due to the rise in the internal pressure.

As described above, the current interruption mechanism of the present embodiment is configured to disconnect the rupture disc 24 from the internal terminal plate 23, whereas the explosion-proof mechanism of the present embodiment is configured to perform two stages of rupture of the groove 24c of the rupture disc 24 and breakage of the explosion-proof vent 35 of the cap 30. However, the explosion-proof mechanism is not necessarily configured to perform two stages. For example, when the rupture disc 24 is provided with a through hole instead of the groove 24c, it is only required that the explosion-proof mechanism performs only breakage of the explosion-proof vent 35 of the cap 30.

The working pressure of the current interruption mechanism is set lower than the working pressure of the explosion-proof mechanism. In the case where an internal short circuit occurs, by cutting off the current pathway in an early stage, excessive current can be prevented from flowing in from the adjacent battery. In the case where the thermal runaway occurs in the battery after the internal short circuit, the gas pressure further rises, but in this case, the groove 24c of the rupture disc 24 and the explosion-proof vent 35 are activated to form a gas discharge pathway to the outside of the battery, thereby preventing the battery from rupturing due to the rise in the gas pressure in the battery. Accordingly, the working pressure of the current interruption mechanism is set preferably lower than the working pressure of the explosion-proof mechanism. The working pressures of the current interruption mechanism and the explosion-proof mechanism can be set by adjusting the thickness of the thin wall portion 23a of the internal terminal plate 23 and the thickness of the explosion-proof vent 35. In general, this can be achieved by designing the thickness of the thin wall portion 23a of the internal terminal plate 23 to be thinner than the thickness of the explosion-proof vent 35. Specifically, such adjustment can be made using the engraved depth. Furthermore, such adjustment can be made using the materials constituting the internal terminal plate 23 and the cap 30.

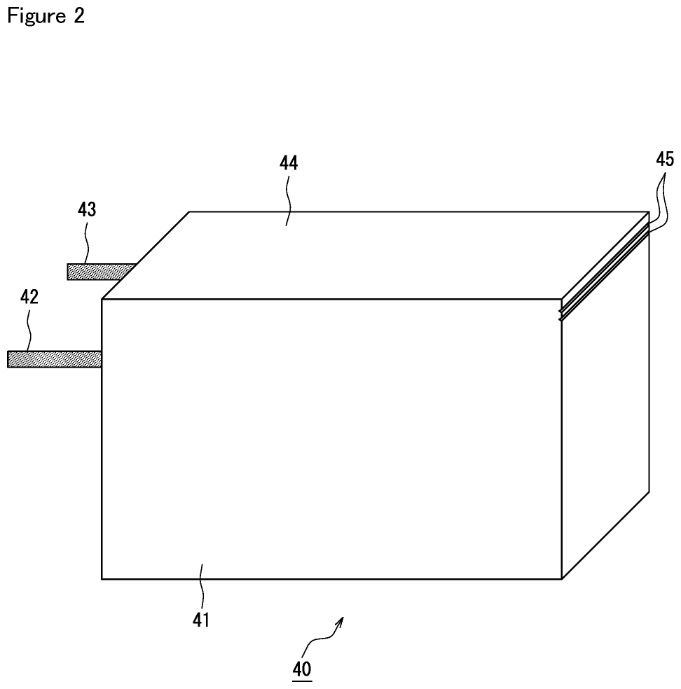

FIG. 2 is a diagram illustrating appearance of a battery pack 40 in which a plurality of the sealed batteries 10 of the present embodiment are housed. The battery pack 40 includes a resin exterior housing case 41 that houses the plurality of sealed batteries 10, and positive electrode terminals 42 and negative electrode terminals 43 which are connection terminals to the outside. The positive electrode terminals 42 and the negative electrode terminals 43 of the battery pack 40 are drawn out from an upper end of one side wall of the exterior housing case 41. The exterior housing case 41 has a gas discharge pathway 44 inside the upper surface formed between the one side wall from which the positive electrode terminals 42 and the negative electrode terminals 43 are drawn out and the other side wall facing the one side wall, and a gas discharge vent 45 in an upper end of the other side wall. The battery pack 40 of the present embodiment has a box shape, but the shape may be changed depending on the number and arrangement of the sealed batteries 10 to be housed therein.

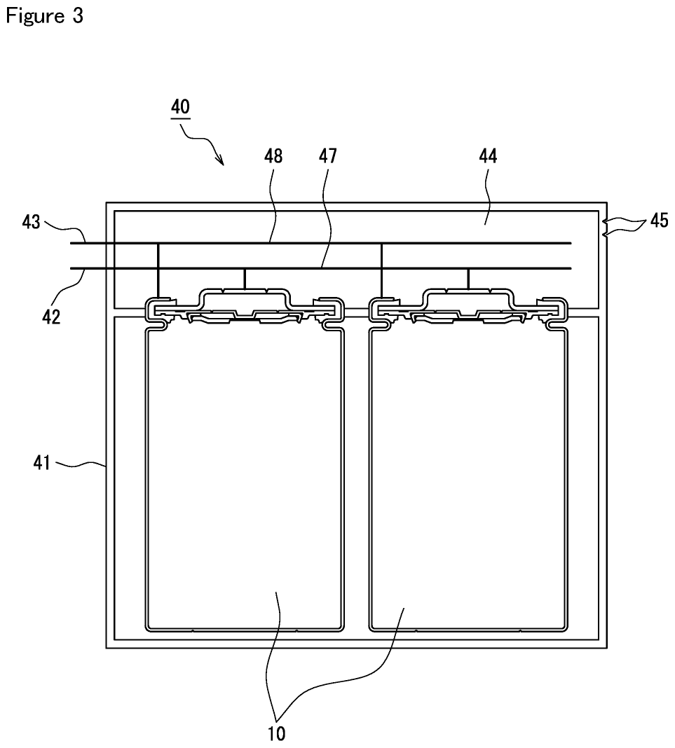

FIG. 3 is a schematic diagram illustrating an internal structure of the battery pack of the present embodiment. The battery pack 40 houses the plurality of sealed batteries 10 therein. In the exterior housing case 41 of the battery pack 40, the plurality of sealed batteries 10 are housed in a state in which all of the positive electrode terminals (caps 30) are aligned in one direction. This enables the positive electrode terminals and the negative electrode terminals to be wired collectively, which contributes to the increase of volume energy density of the battery pack 40.

In the battery pack 40, the positive electrode terminals of the plurality of sealed batteries 10 are connected to a positive electrode current collector plate 47, and the negative electrode terminals are connected to a negative electrode current collector plate 48. The positive electrode current collector plate 47 and the negative electrode current collector plate 48 are connected to the positive electrode terminals 42 and the negative electrode terminals 43, respectively. The positive electrode terminals 42 and the negative electrode terminals 43 are external connection terminals, and are connected to electric connection terminals of an apparatus using the battery pack.

In the battery pack 40, the gas discharge pathway 44 is provided on an upper surface of the positive electrode terminals of the plurality of sealed batteries 10. In the sealed battery 10 of the present embodiment, since the explosion-proof vent 35 is provided on the cap 30 side which is a positive electrode, the gas discharged due to a short circuit, a thermal runaway, or the like can be easily discharged to the outside of the battery pack 40 through the gas discharge pathway 44 provided on the upper surface of the positive electrode terminals. Furthermore, providing the gas discharge pathway 44 on the upper surface of arrangement of the positive electrode current collector plate 47 and the negative electrode current collector plate 48 enables the volume of the battery pack 40 to be reduced and the volume energy density to be increased.

The gas discharge vent 45 of the gas discharge pathway 44 is normally closed to prevent water drops or the like from entering. When the pressure in the battery pack 40 rises, the pressure in the gas discharge pathway 44 rises, and the gas discharge vent 45 is opened so that the gas is discharged to the outside of the battery pack 40. This can prevent the battery pack 40 from expanding in the case where some of the sealed batteries 10 in which abnormalities have occurred discharge gas. Note that the gas discharge vent may be formed by providing a hole above the side wall of the exterior housing case 41 and sealing the hole.

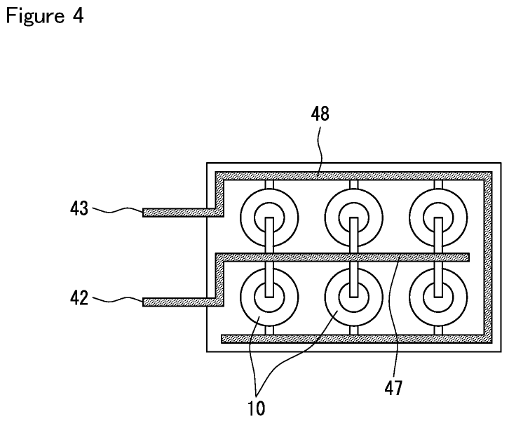

FIG. 4 illustrates an example of arrangement of the positive electrode current collector plate 47 and the negative electrode current collector plate 48. The positive electrode terminals of the sealed batteries 10 are aligned and arranged in one direction, and wires from the positive electrode current collector plate 47 are connected to the caps 30 (positive electrode terminals). Wires from the negative electrode current collector plate 48 are connected to the shoulder portions (negative electrode terminals) of the outer housing cans 16 of the sealed batteries 10. The wires are connected by welding or the like, but can be connected by various methods.

Returning to FIG. 3, there will be described a case where one sealed battery 10 in the battery pack 40 in which an abnormality has occurred discharges gas.

Suppose that the internal terminal plate 23 and the rupture disc 24 are electrically disconnected due to an internal short circuit and a thermal runaway in the battery, the groove 24c of the rupture disc 24 ruptures, and then the explosion-proof vent 35 in the top surface 33 of the cap 30 breaks. High-temperature gas is discharged from the sealed battery 10, and the battery pack 40 and the gas discharge pathway 44 are filled with the gas. In the case of the conventional sealed battery, the gas discharge hole is provided in the cap. Therefore, when the gas is discharged in the battery pack 40, the high-temperature gas flows in from the gas discharge hole, contacts the rupture disc 24 of the normal battery, and thermally affects the normal battery.

The rise in the pressure in the battery pack 40 also affects the working pressure of the rupture disc 24. The rupture disc 24 is activated by a difference between the pressure inside the sealed battery 10 on the electrode assembly 14 side and the pressure outside the rupture disc 24. Therefore, the rise in the pressure outside the battery makes it difficult to activate the rupture disc 24.

On the other hand, in the sealed battery 10 of the present disclosure, since the explosion-proof vent 35 is provided in the cap 30 to provide the sealed structure, the gas is not prevented from flowing in the normal sealed battery 10 even when the battery pack 40 is filled with the gas. Therefore, the rupture disc 24 is less affected by the discharged gas.

Since the gas discharge pathway 44 is provided in the battery pack 40, the gas accumulated in the battery pack 40 is discharged from the gas discharge vent 45 if the pressure becomes greater than or equal to a predetermined pressure, which can prevent the pressure in the battery pack 40 from abnormally rising.

The present disclosure will be further described below with Examples, but the present disclosure is not limited to these Examples.

### Example 1

[Fabrication of Positive Electrode]

A lithium nickel cobalt aluminum oxide as a positive electrode active material, acetylene black as a conductive auxiliary agent, and polyvinylidene difluoride as a binder were used and mixed with an N-methyl pyrrolidone (NMP) solution to obtain a positive electrode mixture slurry. This positive electrode mixture slurry was applied to each surface of the positive electrode current collector made of aluminum, and was dried and rolled to obtain a positive electrode.

[Fabrication of Negative Electrode]

Graphite and a silicon-based compound as negative electrode active materials, carboxymethyl cellulose (CMC) as a thickener, and styrene-butadiene rubber (SBR) as a binder were used and mixed with water to a negative electrode mixture slurry. This negative electrode mixture slurry was applied to each surface of the negative electrode current collector made of copper, and was dried and rolled to obtain a negative electrode.

[Fabrication of Electrode Assembly]

The above-described positive electrode and negative electrode were wound with the micro-porous membrane separator made of polyethylene interposed therebetween to obtain an electrode assembly.

[Preparation of Non-Aqueous Electrolyte]

Ethylene carbonate (EC) and methyl ethyl carbonate (EMC), and dimethyl carbonate (DMC) were mixed together to obtain a non-aqueous solvent. Lithium hexafluorophosphate (LiPF6) as an electrolyte salt was dissolved in the non-aqueous solvent to obtain a non-aqueous electrolyte.

[Fabrication of Secondary Battery]

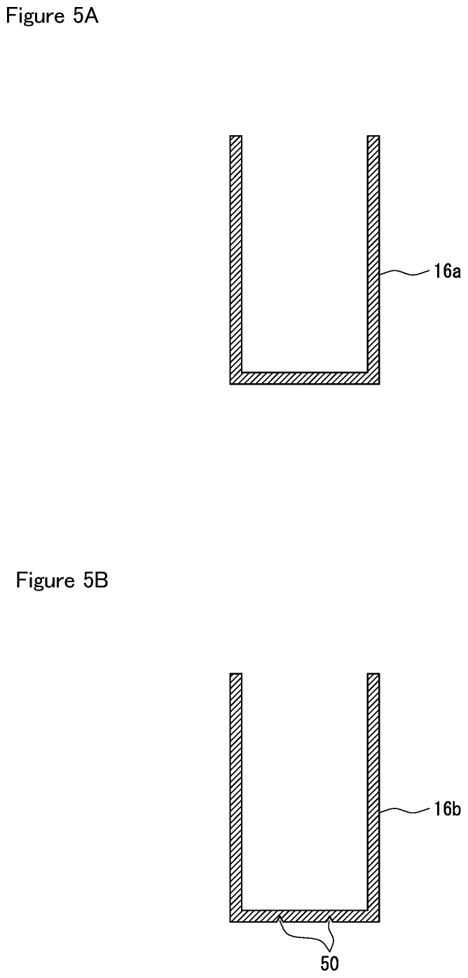

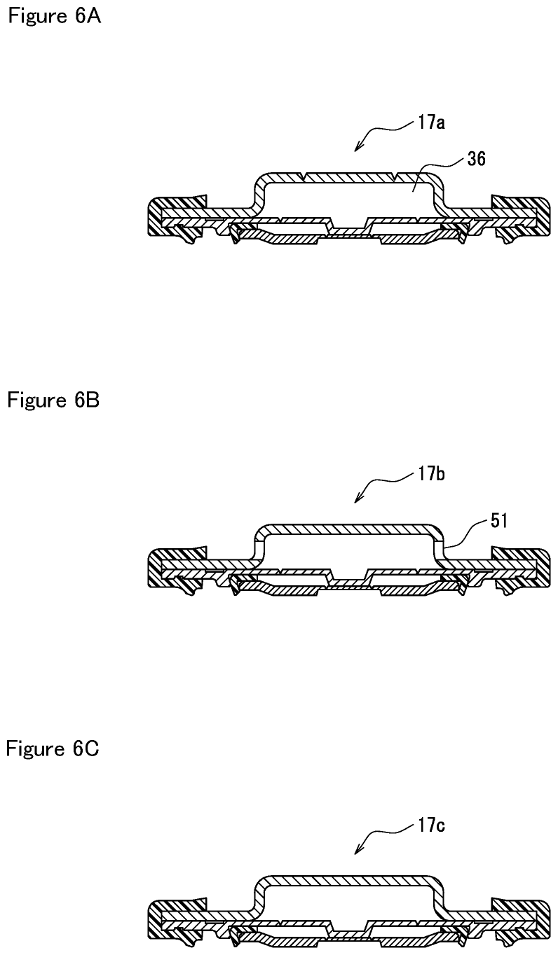

The electrode assembly was inserted into the cylindrical outer housing can 16a illustrated in FIG. 5A, the non-aqueous electrolyte was injected, and the sealing assembly 17a illustrated in FIG. 6A was caulked to an opening end of the outer housing can 16a, to complete a sealed battery. The sealing assembly 17a has an explosion-proof vent on the top surface of the sealing assembly, and a sealed space is formed between the rupture disc and the sealing assembly.

[Fabrication of Battery Pack]

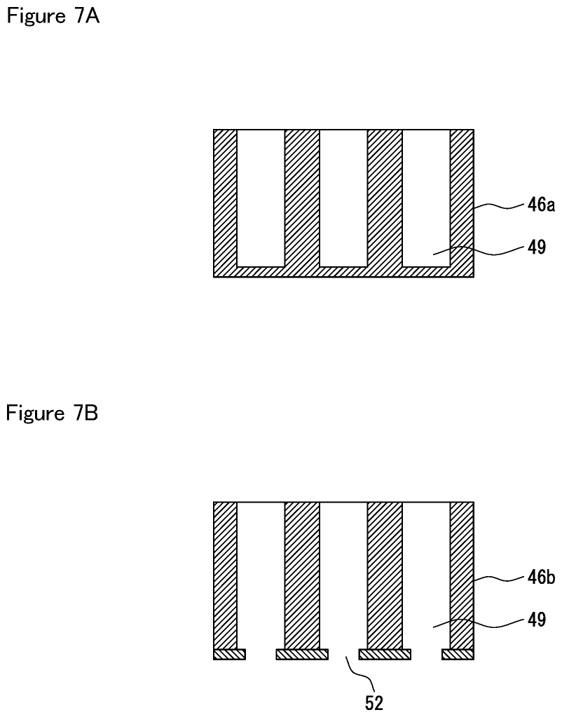

The six sealed batteries fabricated by the above-described method were inserted into a battery insertion portion 49 in a battery holder 46a having a rectangular parallelepiped shape illustrated in FIG. 7A, the positive electrode current collector plate and the negative electrode current collector plate were placed, the sealed batteries and the current collector plates were welded and inserted into the exterior housing case, to fabricate a battery pack.

### Comparative Example 1

A battery pack was fabricated in the same manner as in Example 1 except that the sealing assembly 17b provided with a gas discharge hole 51 in the top surface as illustrated in FIG. 6B was used instead of the sealing assembly 17a of the battery pack in Example 1.

### Comparative Example 2

The sealing assembly 17C provided with neither explosion-proof vent nor gas discharge hole in the top surface as illustrated in FIG. 6C was used instead of the sealing assembly 17a of the battery pack in Example 1. A gas discharge pathway was provided in bottom of the sealed battery using, instead of the outer housing can 16a, the outer housing can 16b having the explosion-proof mechanism 50 in the bottom as illustrated in FIG. 5B and using, instead of the battery holder 46a, the battery holder 46b having the gas discharge hole 52 in the bottom of the battery insertion portion 49 as illustrated in FIG. 7B. Except for the facts described above, a battery pack was fabricated in the same manner in Example 1.

### Example 2

A battery pack was fabricated in the same manner as in Example 1 except that the battery pack of Example 1 was sealed with a polyvinyl chloride (PVC) film.

### Comparative Example 3

A battery pack was fabricated in the same manner as in Example 1 except that the battery pack of Comparative Example 1 was sealed with a polyvinyl chloride (PVC) film.

[Verification Experiment]

The volume energy density (Wh/L) of each battery pack was calculated from an outer diameter size of the battery pack of each of Examples 1 and 2 and Comparative Examples 1 to 3.

An influence on the adjacent battery at the time of a thermal runaway of the battery was evaluated by the following procedure. The battery pack was fully charged in an atmosphere at 25° C., and the sealed battery was forcibly subjected to a thermal runaway by driving a nail from a side wall of the battery pack. The battery pack was disassembled after being sufficiently cooled up to 25° C. and a sealed battery adjacent to the sealed battery forcibly subjected to the thermal runaway was taken out from the battery pack. The adjacent sealed battery was disassembled and the sealing assembly was taken out from the adjacent sealed battery to measure the working pressure (MPa) of the current interruption mechanism.

The reliability measure at the time of a thermal runaway of the battery was evaluated by the following procedure. First, the battery pack was continuously charged at a current of one hour rate in an atmosphere at 25° C., to measure a time T1 when the current interruption mechanism was activated and the current stopped flowing. Next, another battery pack was continuously charged at a current of one hour rate in an atmosphere at 25° C., and the sealed battery was forcibly subjected to a thermal runaway by driving a nail from a side wall on the battery pack side at the time point of (T1—3 seconds), to measure, as the reliability measure, a time T2 when the current interruption mechanism of the adjacent sealed battery was activated and the current stopped flowing.

[Evaluation Result]

With regard to each of the battery packs, Table 1 shows the volume energy density (Wh/L) of the battery pack, the working pressure (MPa) of the current interruption mechanism of the adjacent battery after the thermal runaway of the battery, and T2 as the reliability measure at the time of the thermal runaway of the battery. The evaluation results of the volume energy density of the battery pack and the working pressure of the current interruption mechanism of the adjacent battery after the thermal runaway of the battery were expressed by indexing the numerical value in Example 1 as 100.

TABLE 1

| | | | | | | Current | Adjacent |
|---|---|---|---|---|---|---|---|
| | | | Gas discharge pathway position | | Volume | interruption | potential |
| | | | | Presence | energy | pressure of | current |
| Experiment | Sealing assembly top | Explosion-proof | | or absence | density | adjacent | interruption |
| examples | surface structure | vent mechanism | Position | of sealing | (index) | battery | time T2 |
| Example 1 | Without gas discharge hole | Top surface | Battery sealing | No | 100 | 100 | 3 |
| | | of sealing assembly | assembly side | | | | |
| Example 2 | Without gas discharge hole | Top surface | Battery sealing | Yes | 100 | 100 | 3 |
| | | of sealing assembly | assembly side | | | | |
| Comparative | With gas discharge hole | In sealing assembly | Battery sealing | No | 100 | 89 | 7 |
| Example 1 | | | assembly side | | | | |
| Comparative | Without gas discharge hole | Bottom of battery case | Battery sealing | No | 94 | 100 | 3 |
| Example 2 | | | assembly side | | | | |
| Comparative | With gas discharge hole | In sealing assembly | Battery sealing | Yes | 100 | 87 | 8 |
| Example 3 | | | assembly side | | | | |

Comparing with Comparative Examples 1 and 3 in which a gas discharge hole is provided in the top surface of the sealing assembly, it can be seen from Table 1 that the battery in each of Examples 1 and 2 in which no gas discharge hole is provided in the top surface of the sealing assembly and Comparative Example 2 does not show a reduction of the current interruption pressure of the adjacent battery. Thus, it is considered that a configuration in which no gas discharge hole is provided in the top surface of the sealing assembly can suppress a thermal influence of high-temperature gas on the current interruption mechanism at the time of the thermal runaway of the adjacent battery.

Furthermore, comparing with Comparative Examples 1 and 3, it can be seen that in the battery in each of Examples 1 and 2, the current interruption time T2 of the adjacent battery is 3 sec. and the delay is not caused. This is considered that since the current interruption mechanism of the battery in each of Examples 1 and 2 is configured to be activated by a difference between the pressure of the sealed space between the cap in the battery and the current interruption mechanism and the pressure of the battery power generation portion, the battery is less affected by the rise in the pressure in the battery pack due to the discharge of high-temperature gas from the adjacent battery. On the other hand, it is considered that since the battery in each of Comparative Examples 1 and 3 is provided with a gas discharge hole in the top surface of the sealing assembly, the pressure in the battery pack rises due to the discharge of high-temperature gas from the adjacent battery, and the contact pressure with the current interruption mechanism through the gas discharge hole also rises, and the current interruption time is delayed.

As described above, it can be seen that the battery pack in each of Examples 1 and 2 in which the gas discharge hole is not provided in the top surface of the sealing assembly can ensure the reliability at the time of the thermal runaway of the battery while maintaining the high volume energy density comparing with the battery pack in each of Comparative Examples 1 to 3.

### REFERENCE SIGNS LIST

Sealed battery, 11 Positive electrode, 12 Negative electrode, 13 Separator, 14 Electrode assembly, 16, 16a, 16b Outer housing can, 17, 17a, 17b, 17c Sealing assembly, 18, 19 Insulating plate, 20 Positive electrode lead, 21 Negative electrode lead, 22 Grooved portion, 23 Internal terminal plate, 23a Thin wall portion, 23b Notched portion, 24 Rupture disc, 24a Projection, 24b Recess, 24c Groove, 25 Insulating member, 27 Gasket, 28 Caulking portion, 29 Bottomed cylindrical portion, 30 Cap, 31 Bottom, 32 Flange, 33 Top surface, 34 Side wall, 35 Explosion-proof vent, 36 Sealed space, 40 Battery pack, 41 Exterior housing case, 42 Positive electrode terminal, 43 Negative electrode terminal, 44 Gas discharge pathway, 45 Gas discharge vent, 46a, 46b Battery holder, 47 Positive electrode current collector plate, 48 Negative electrode current collector plate, 49 Battery insertion portion, 50 Explosion-proof mechanism, 51, 52 Gas discharge hole

1. A sealed battery, comprising:
a bottomed cylindrical outer housing can that houses an electrode assembly; and
a sealing assembly that closes an opening of the outer housing can, wherein
the sealing assembly has a current interruption mechanism that seals the electrode assembly in cooperation with the outer housing can and is activated sensitive to a gas pressure in the battery and a cap that forms a sealed space above the current interruption mechanism, and
the cap has an explosion-proof vent that opens sensitive to a gas pressure in the sealed space.

2. The sealed battery according to claim 1, wherein
sensitive characteristics of the current interruption mechanism and the explosion-proof vent are adjusted so that the explosion-proof vent is activated after the current interruption mechanism is activated.

3. A battery pack having a plurality of the sealed batteries according to claim 1, wherein
positive electrode terminals of the plurality of sealed batteries are aligned and arranged in one direction in the battery pack.

4. The battery pack according to claim 3, wherein
a closed gas discharge pathway is further included in the battery pack in which the positive electrode terminals of the plurality of sealed batteries are arranged.

5. The battery pack according to claim 4, wherein
the gas discharge pathway includes a gas discharge vent that opens when gas is discharged from the sealed battery and a pressure in the battery pack rises.
